(19) United States
(12) Patent Application Publication
(10) Pub. No.: US 2022/0268938 A1
(43) Pub. Date: Aug. 25, 2022

(54) SYSTEMS AND METHODS FOR BOUNDING BOX REFINEMENT

(71) Applicants: Denso International America, Inc., Southfield, MI (US); Carnegie Mellon University, Pittsburgh, PA (US)

(72) Inventors: Prasanna Sivakumar, Pittsburgh, PA (US); Kris Kitani, Pittsburgh, PA (US); Matthew O'Toole, Pittsburgh, PA (US); Yunze Man, Pittsburgh, PA (US); Xinshuo Weng, Pittsburgh, PA (US)

(21) Appl. No.: 17/183,684

(22) Filed: Feb. 24, 2021

(51) Int. Cl. G01S 17/89; G06K 9/00; G01S 17/66; G01S 17/931

(52) U.S. Cl. CPC G01S 17/89; G06K 9/00208; G01S 17/66; G01S 17/931; G06K 2209/19

(57) ABSTRACT

In one embodiment, a method includes receiving sensor data. The sensor data is based on information from a first set of echo points and a second set of echo points. At least one echo point from the first set of echo points and one echo point from the second set of echo points originate from a single beam. The method includes generating a first set of feature maps based on the first set of echo points and a second set of feature maps based on the second set of echo points. The method includes predicting a bounding box for the object based on the first set of feature maps and the second set of feature maps.

### TECHNICAL FIELD

The subject matter described herein relates in general to systems and methods for refining a bounding box.

### BACKGROUND

Perceiving an environment can be an important aspect for many different computational functions, such as automated vehicle assistance systems. However, accurately perceiving the environment can be a complex task that balances computational costs, speed of computations, and an extent of accuracy. For example, as a vehicle moves more quickly, the time in which perceptions are to be computed is reduced since the vehicle may encounter objects more quickly. Additionally, in complex situations, such as intersections with many dynamic objects, the accuracy of the perceptions may be preferred.

### SUMMARY

In one embodiment, a method for detecting an object is disclosed. The method includes receiving sensor data. The sensor data can be based on information from a first set of echo points and a second set of echo points. At least one echo point from the first set of echo points and one echo point from the second set of echo points can originate from a single beam. The method can include generating a first set of feature maps based on the first set of echo points and a second set of feature maps based on the second set of echo points. The method can include predicting a bounding box for the object based on the first set of feature maps and the second set of feature maps.

In another embodiment, a system for detecting an object is disclosed. The system includes a processor and a memory in communication with the processor. The memory stores a feature generation module including instructions that when executed by the processor cause the processor to receive sensor data. The sensor data can be based on information from a first set of echo points and a second set of echo points. At least one echo point from the first set of echo points and one echo point from the second set of echo points can originate from a single beam. The memory stores the feature generation module including instructions that when executed by the processor cause the processor to generate a first set of feature maps based on the first set of echo points and a second set of feature maps based on the second set of echo points. The memory stores a bounding box generation module including instructions that when executed by the processor cause the processor to predict a bounding box for the object based on the first set of feature maps and the second set of feature maps.

In another embodiment, a non-transitory computer-readable medium for detecting an object and including instructions that when executed by a processor cause the processor to perform one or more functions, is disclosed. The instructions include instructions to receive sensor data. The sensor data can be based on information from a first set of echo points and a second set of echo points. At least one echo point from the first set of echo points and one echo point from the second set of echo points can originate from a single beam. The instructions include instructions to generate a first set of feature maps based on the first set of echo points and a second set of feature maps based on the second set of echo points. The instructions include instructions to predict a bounding box for the object based on the first set of feature maps and the second set of feature maps.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of an object detection system that includes a bounding box refinement system.

FIGS. 2A-2C illustrate an example of multiple echo points originating from a single beam.

FIG. 3 illustrates one embodiment of the bounding box refinement system.

FIG. 4 illustrates one embodiment of a dataflow associated with generating bounding boxes and object classes.

FIG. 5 illustrates one embodiment of a method associated with generating bounding boxes and object classes.

FIG. 6 illustrates an example of a bounding box refinement and an object classification scenario with a sensor located at a crosswalk.

### DETAILED DESCRIPTION

Systems, methods, and other embodiments associated with refining a bounding box and classifying a detected object are disclosed.

Object detection processes can include the use of bounding boxes and object classes. Bounding boxes are markers that identify objects detected in an image. Object classes identify what the detected object may be. Bounding boxes can be used to solve object localization more efficiently. As such, object detection processes can typically perform object classification in the regions identified by the bounding boxes, making the process more accurate and efficient.

In various approaches, bounding box refinement and object classification can be generated based on feature maps. Feature maps can include information that characterize sensor data. Feature maps can be generated based on echo points. Sensors, such as LiDAR sensors, can emit a beam and upon hitting an object, the beam is reflected off the object, creating an echo point. The feature maps can be generated by applying machine learning techniques to the echo points.

In certain cases, the LiDAR sensor can emit a single beam that split into two or more echo points as the single beam reflects off one or more surfaces. As an example, this may occur when the beam reflects off an edge of the object. As another example, this may occur when the beam hits a transparent or translucent surface. The returning echo points may have different intensity values and/or different range values. The intensity value of the echo point can refer to the strength of the echo point. The range value of the echo point can refer to the distance travelled by the echo point between the object and the sensor.

As previously mentioned, feature maps can be generated by applying machine learning techniques to the echo points. However, in prior technologies where multiple echo points originate from a single beam, the multiple echo points can be combined into a single echo point, which is used to learn the feature map. In other prior technologies, some of the multiple echo points can be discarded and the remaining echo points can be used to learn the feature map. As such, information about the object contained in the combined or discarded echo points may be lost, and may not be available for machine learning and generating the feature maps.

Accordingly, in one embodiment, the disclosed approach is a system that detects an object by predicting a bounding for the object and classifying the object using the multiple echo points originating from a single beam. The system can receive sensor data that is based on a first set of echo points and a second set of echo points. The sensor data can be processed sensor data originating from, as an example, a SPAD (Single Photon Avalanche Diode) LiDAR sensor. The sensor data can include 3-dimensional (3D) features. Additionally, the sensor data can include bounding box proposals. 3D features can include 3D object center location estimates and characteristics of related echo points. A 3D object center location estimate is the estimated distance between the capturing sensor and the estimated center of the detected object. The characteristics of the related echo points can include an intensity value of the echo point, a range value of the echo point, and/or whether the echo point is a penetrable point or an impenetrable point. Bounding box proposals are markers that identify regions within an image that may have an object.

In some embodiments, the system can generate multiple feature maps based on the multiple echo points using any suitable machine learning techniques. The system can use multiple neural networks to learn and generate the feature maps. The system can then concatenate the resulting feature maps. The system can generate region of interest (ROI) features for each proposed bounding box based on the concatenated feature maps. The ROI features can include information that characterizes the sensor data and/or echo points within the proposed bounding boxes.

Using the ROI features, the system can predict a bounding box, which may be a refinement of the bounding box proposals and may also be more accurate relative to the position of the object. Similarly, the system can predict an object class for the detected objects identified in the bounding box and/or the bounding box proposals.

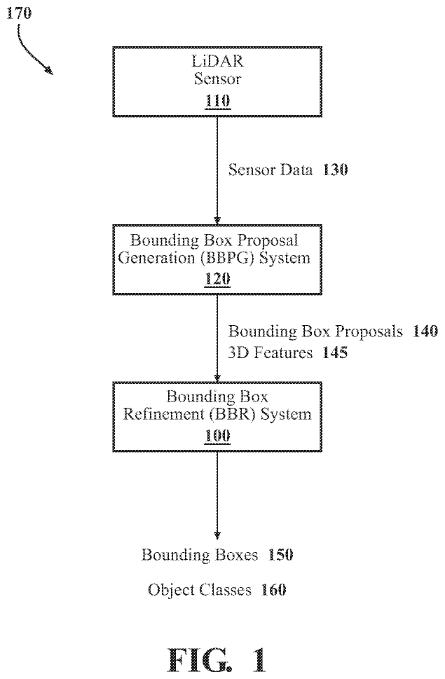

Referring to FIG. 1, one embodiment of an object detection system 170 that includes a bounding box refinement (BBR) system 100 is illustrated. The object detection system 170 also can include a LiDAR sensor 110 and a bounding box proposal generation (BBPG) system 120. The LiDAR sensor 110 outputs sensor data 130 based on its environment. The sensor data can be based on information from one or more echo points. The BBPG system 120 can receive the sensor data 130 from the LiDAR sensor 110. The BBPG system 120 can apply any suitable machine learning mechanisms to the sensor data 130 to generate bounding box proposals 140 and 3D features 145. In one embodiment, the BBR system 100 can receive the 3D features 145. In another embodiment, the BBR system can receive the bounding box proposals 140 and the 3D features. Based on the received information, the BBR system 100 can determine a final representation for the bounding box 150 of an object as well as an object class 160 for the object.

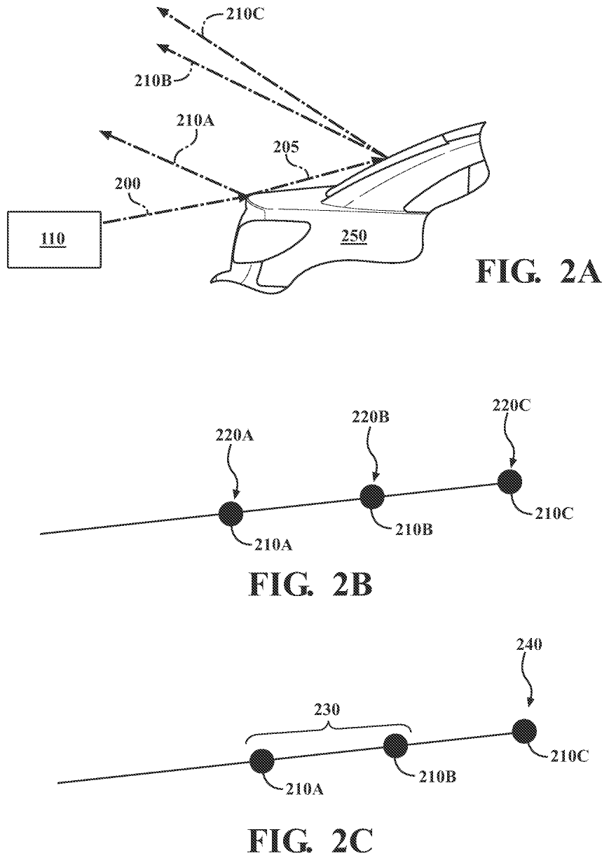

FIGS. 2A-2C illustrate an example of a plurality of echo points 210A, 210B, 210C (collectively known as 210) originating from a single beam 200. As shown in FIG. 2A, the LiDAR sensor 110 can emit a single beam 200 that hits an object, in this case, a vehicle 250. The single beam 200 can split upon hitting an edge of the vehicle 250. As an example, the single beam 200 can split into a first echo point 210A and a continuing beam 205. The continuing beam 205 can split upon hitting a second edge of the vehicle 250, creating a second echo point 210B and a third echo point 210C.

An example of a method of grouping the echo points 210A, 210B, 210C into sets is shown in FIG. 2B. In this example, the three echo points 210A, 210B, 210C are grouped or mapped to three sets of echo point 220A, 220B, 220C respectively. In other words, the first echo point 210A is mapped to a first set of echo points 220A, the second echo point 210B is mapped to a second set of echo points 220B, and the third echo point 210C is mapped to a third set of echo points 220C.

Another example of a method of grouping the echo points 210 into sets is shown in FIG. 2C. In this example, the echo points 210 can be grouped into two echo point clouds 230, 240 based on any suitable criteria. As an example, the echo points 210 can be grouped based on distance travelled to return to the sensor 110. In such an example, the echo point 210C that returns from the farthest point is assigned to a set of impenetrable echo points 240 and the remaining echo points 210A, 210B are assigned to a set of penetrable echo points 230.

As an example, the echo points 210A, 210B in the penetrable echo point cloud 230 can be echo points that reflect off a first surface and return to the sensor 110, while other portions 205 of the originating beam 200 travel on, past the first surface. In one example and as shown, the other portion 205 of the beam 200 can travel on by reflecting off the first surface onto a second surface. The portion 205 of the beam 200 can reflect off the second surface and the resulting echo points 210B, 210C can return to the sensor 110. In another example, a portion of the beam 200 can travel through the first surface, where the first surface is a transparent or translucent surface. In such an example, a portion of the beam 200 can reflect off a second surface behind the first surface and return to the sensor 110. As mentioned above, the echo point 210C in the set of impenetrable echo points 240 can be an echo point that reflects off the farthest surface, and returns to the sensor 110.

As another example, the echo point 210A that returns first can be assigned to the first set of echo points and the remaining echo point 210B, 210C can be assigned to the second set of echo points. As another example, the criteria may be based on the intensity or strength of the echo points 210.

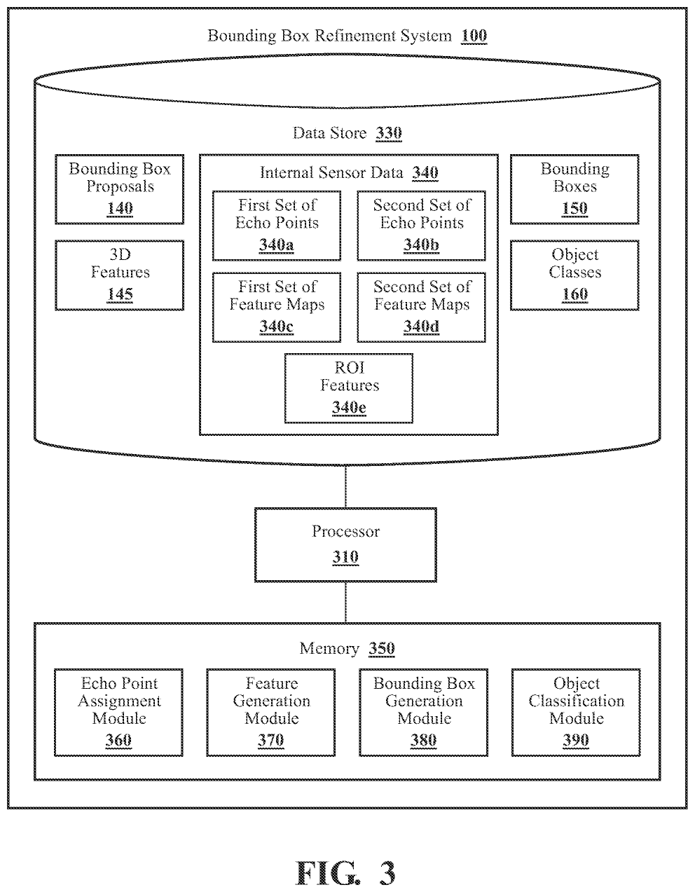

Referring to FIG. 3, one embodiment of a BBR system 100 is illustrated. As shown, the BBR system 100 includes a processor 310. Accordingly, the processor 310 may be a part of the BBR system 100, or the BBR system 100 may access the processor 310 through a data bus or another communication pathway. In one or more embodiments, the processor 310 is an application-specific integrated circuit that is configured to implement functions associated with an echo point assignment module 360, a feature generation module 370, a bounding box generation module 380, and an object classification module 390. More generally, in one or more aspects, the processor 310 is an electronic processor such as a microprocessor that is capable of performing various functions as described herein when executing encoded functions associated with the BBR system 100.

In one embodiment, the BBR system 100 includes a memory 350 that can store the echo point assignment module 360, feature generation module 370, the bounding box generation module 380, and the object classification module 390. The memory 350 is a random-access memory (RAM), read-only memory (ROM), a hard disk drive, a flash memory, or other suitable memory for storing the modules 360, 370, 380, and 390. The modules 360, 370, 380, and 390 are, for example, computer-readable instructions that, when executed by the processor 310, cause the processor 310 to perform the various functions disclosed herein. While, in one or more embodiments, the modules 360, 370, 380, and 390 are instructions embodied in the memory 350, in further aspects, the modules 360, 370, 380, and 390 include hardware, such as processing components (e.g., controllers), circuits, etcetera for independently performing one or more of the noted functions.

Furthermore, in one embodiment, the BBR system 100 can include a data store 330. The data store 330 is, in one embodiment, an electronically-based data structure for storing information. In one approach, the data store 330 is a database that is stored in the memory 350 or another suitable storage medium, and that is configured with routines that can be executed by the processor 310 for analyzing stored data, providing stored data, organizing stored data, and so on. In any case, in one embodiment, the data store 330 can store data used by the modules 360, 370, 380, and 390 in executing various functions. In one embodiment, the data store 330 can include bounding box proposals 140, 3D features 145, internal sensor data 340, bounding boxes 150, object classes 160 along with, for example, other information that is used by the modules 360, 370, 380, and 390.

In general, “sensor data” means any information that embodies observations of one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process. Further, “internal sensor data” means any sensor data that is being processed and used for further analysis within the BBR system 100.

The BBR system 100 can be operatively connected to the one or more sensors. More specifically, the one or more sensors can be operatively connected to the processor(s) 310, the data store(s) 330, and/or another element of the BBR system 100. In one embodiment, the sensors can be internal to the BBR system 100, external to the BBR system 100, or a combination thereof.

The sensors can include any type of sensor capable of generating 3D sensor data based on multiple echo points. 3D sensor data can be in the form of echo point clouds. Various examples of different types of sensors will be described herein. However, it will be understood that the embodiments are not limited to the particular sensors described. As an example, in one or more arrangements, the sensors can include one or more LIDAR sensors. The LIDAR sensors can include conventional LiDAR sensors, Single Photon Avalanche Diode (SPAD) based LiDAR sensors and/or any LIDAR sensor capable of outputting laser beams and receiving multiple echo points originating from one laser beam. As disclosed above, the multiple echo points can have different intensity values and/or different range values. In one embodiment, the LIDAR sensor or any suitable device can generate multiple sets of echo points based on the multiple echo points. As an example and as previously mentioned, if three echo points originate from a single beam, the LIDAR sensor can create three sets of echo points or point clouds. In such an example, the first point cloud can include information from the first of the three echo points, the second point cloud can include information from the second echo point, and the third point cloud can include information from the third echo point.

In one embodiment, the echo point assignment module 360 can include instructions that function to control the processor 310 to determine whether to assign an echo point 210 to a first set of echo points 340a or a second set of echo points 340b based on whether the echo point 210 is a penetrable point or an impenetrable point. As mentioned above, a penetrable point can be an echo point 210 that reflects off a surface that other portions of the originating beam 200 travel past. An impenetrable point is an echo point 210 that reflects off the farthest surface relative to other echo points 210 that originate from the same beam 200. The echo point assignment module 360 can receive the 3D features 145 and parse the information in the 3D features 145 to determine whether the related echo point 210 is an impenetrable point or a penetrable point. As an example, the 3D features 145 can include a field that is set to one or zero to indicate whether the related echo point 210 is an impenetrable point or a penetrable point. The echo point assignment module 360 can extract the information in that field to determine whether the related echo point 210 is an impenetrable point or a penetrable point. In the case that the echo point 210 is an impenetrable point, the echo point assignment module 360 can assign the related 3D features 145 to the first set of echo points 340a. In this case, the first set of echo points can be the impenetrable echo point cloud 240. In the case that the echo point 210 is a penetrable point, the echo point assignment module 360 can assign the related 3D features 145 to the second set of echo points 340b, which can be the penetrable echo point cloud 230.

In one embodiment, the echo point assignment module 360 can include instructions that function to control the processor 310 to determine whether to assign an echo point 210 to the first set of echo points 340a or the second set of echo points 340b based on an intensity value of the echo point 210. As an example, the echo point assignment module 360 can include an intensity value threshold, which can be arbitrarily set or can be programmable by a user.

The 3D features 145 can include information about the intensity value of a related echo point 210. As an example, the echo point assignment module 360 can parse the information and extract the intensity value. In such an example, the echo point assignment module 360 can assign echo points 210 with intensity values that are higher than the intensity value threshold to the first set of echo points 340a and echo points with intensity values that are equal to or lower than the intensity value threshold to the second set of echo points 340b.

In one embodiment, the echo point assignment module 360 can include instructions that function to control the processor 310 to determine whether to assign an echo point to the first set of echo points 340a or the second set of echo points 340b based on a range value of the echo point 210. As an example, the echo point assignment module 360 can include a range value threshold, which can be arbitrarily set or can be programmable by a user.

The 3D features can include information about the range value of a related echo point 210. As an example, the echo point assignment module 360 can parse the information and extract the range value. In such an example, the echo point assignment module 360 can assign echo points 210 with range values that are higher than the range value threshold to the first set of echo points 340a and echo points with range values that are equal to or lower than the range value threshold to the second set of echo points 340b.

In one embodiment, the feature generation module 370 can include instructions that function to control the processor 310 to receive sensor data. The sensor data can include the bounding box proposals 140 and the 3D features 145, and can be based on information from the first set of echo points 340a and the second set of echo points 340b. In such a case, at least one echo point from the first set of echo points 340a and one echo point from the second set of echo points 340b can originate from a single beam as described above.

The feature generation module 370 can generate a first set of feature maps 340c based on the first set of echo points 340a and a second set of feature maps 340d based on the second set of echo points 340b. In addition to the first and second sets of echo points 340a, 340b, the feature generation module 370 can generate feature maps 340c, 340d based on bounding box proposals 140. The feature generation module 370 can learn the first set of feature maps 340c using the first set of echo points 340a and any suitable machine learning mechanism. The feature generation module 370 can also learn the second set of feature maps 340d using the second set of echo points 340b and any suitable machine learning mechanism. As an example, the feature generation module 370 can learn the first and second sets of feature maps 340c, 340d using a neural network such as a multilayer perceptron (MLP) followed by a point-wise pooling.

In another embodiment, the feature generation module 370 can generate a plurality of feature maps based on a plurality of sets of echo points. In such an embodiment and as an example, the feature generation module 370 can include four sets of echo points and four neural networks. In this example, the feature generation module 370 can learn four sets of feature maps by learning each set of feature maps from one of the four sets of echo points using one of the four neural networks.

In one embodiment, the feature generation module 370 can concatenate the sets of feature maps together. As an example, the feature generation module 370 can concatenate the first and second sets of feature maps 340c, 340d. In such an example, if the first and second sets of feature maps 340c, 340d are each 64 bits long, the concatenation of the first and second sets of feature maps 340c, 340d can be twice as long at 128 bits if the data bits from the first and second sets of feature maps 340c, 340d are arranged side by side. In the case where the first and second sets of feature maps 340c, 340d are arranged one after the other, the resulting concatenation can remain 64 bits wide but be twice as long.

In one embodiment, the feature generation module 370 can include instructions that function to control the processor 310 to generate ROI features 340e based on the first set of feature maps 340c and the second set of feature maps 340d. In such an embodiment, the feature generation module 370 can learn the ROI features 340e using the first and second set of feature maps 340c, 340d and any suitable machine learning mechanism such as a PointNet Neural Network.

In another embodiment, the feature generation module 370 can generate ROI features 340e based on the plurality of bounding box proposals 140, the first set of feature maps 340c and the second set of feature maps 340d. In such an embodiment, the feature generation module 370 can learn the ROI features 340e using the bounding box proposals 140, the first and second set of feature maps 340c, 340d and any suitable machine learning mechanisms such as a PointNet Neural Network. By including the bounding box proposals 140, the feature generation module 370 can focus on learning the ROI features 340e of regions identified by the bounding box proposals 140. This can enhance the efficiency and accuracy of the learning process.

The bounding box generation module 380 can include instructions that function to control the processor 310 to predict a bounding box 150 for an object based on the first set of feature maps 340c and the second set of feature maps 340d. The bounding box generation module 380 can receive the ROI features 340e generated by the feature generation module 370 using the first and second sets of feature maps 340c, 340d. The bounding box generation module 380 can predict a bounding box 150 by learning from the ROI features 340e using any suitable machine learning mechanism such as a neural network. As an example, the bounding box generation module 380 can perform proposal regression to determine and generate the bounding box 150 for an object.

The object classification module 390 can include instructions that function to control the processor 310 to classify an object based on the first set of feature maps 340c and the second set of feature maps 340d. The object classification module 390 can receive the ROI features 340e generated by the feature generation module 370 using the first and second sets of feature maps 340c, 340d. The object classification module 390 can classify the object by learning from the ROI features 340e using any suitable machine learning mechanism such as a neural network. As an example, the object classification module 390 can perform confidence estimation to classify the object and generate the object class 160.

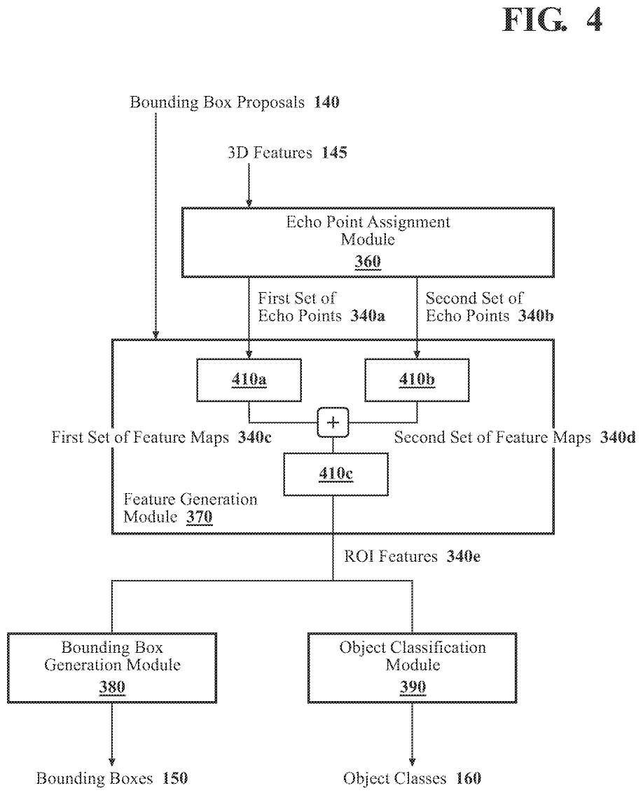

FIG. 4 illustrates one embodiment of a dataflow associated with generating bounding boxes 150 and an object classes 160. As shown, the echo point assignment module 360 can receive 3D features 145 and assign the related echo points 210 to a first set of echo points 340a or a second set of echo points 340b based on a criteria such as those mentioned above.

The feature generation module 370 can receive the bounding box proposals 140, the first set of echo points 340a, and the second set of echo points 340b. The feature generation module 370 can learn the first set of feature maps 340c using the first set of echo points 340a and a first neural network 410a. The feature generation module 370 can learn the second set of feature maps 340d using the second set of echo points 340b and a second neural network 410b. The first and second sets of feature maps 340c, 340d can be combined. The feature generation module 370 can learn the ROI features using the combined first and second sets of feature maps 340c, 340d and a third neural network 410c. In some embodiments, the feature generation module 370 can use the bounding box proposals 140 in the learning process.

The bounding box generation module 380 can receive the ROI features 340e from the feature generation module 370. The bounding box generation module 380 can generate and output a bounding box 150 for the object based on the ROI features 340e. The object classification module 390 can receive the ROI features 340e from the feature generation module 370. The object classification module 390 can classify an object and output the object class 160 based on the ROI features 340e.

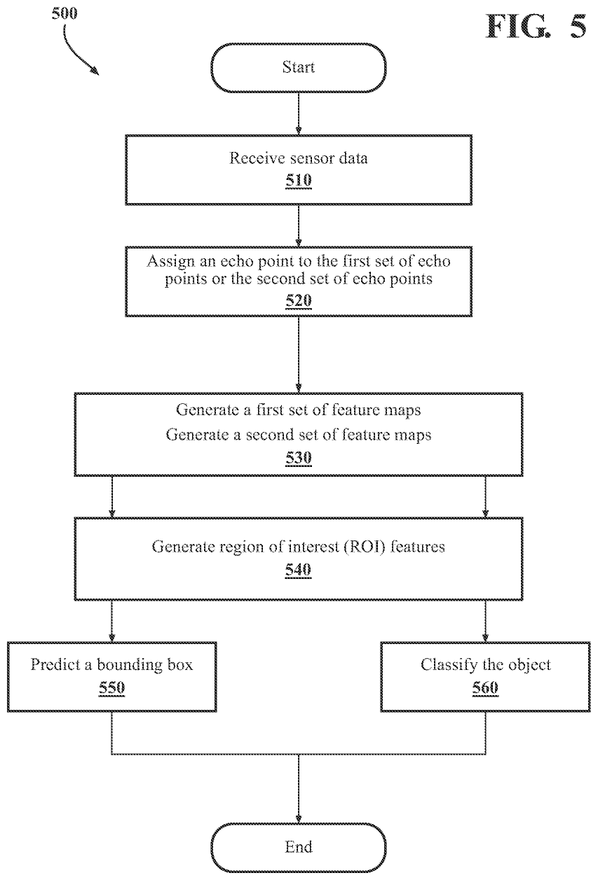

FIG. 5 illustrates a method 500 for generating bounding boxes 150 and object classes 160. The method 500 will be described from the viewpoint of the BBR system 100 of FIGS. 1-4. However, the method 500 may be adapted to be executed in any one of several different situations and not necessarily by the BBR system 100 of FIGS. 1-4.

At step 510, the feature generation module may cause the processor 310 to receive sensor data 130. Additionally and/or alternatively, the echo point assignment module 360 may cause the processor 310 to receive the sensor data. The sensor data can be based on information from the first set of echo points 340a and a second set of echo points 340b. As previously mentioned, at least one echo point from the first set of echo points 340a and one echo point from the second set of echo points 340b can originate from a single beam. The feature generation module 370 and/or the echo point assignment module 360 may employ active or passive techniques to acquire the sensor data 130.

At step 520, the echo point assignment module 360 may cause the processor 310 to assign an echo point to the first set of echo points 340a or the second set of echo points 340b based on any suitable criteria. In one embodiment, the echo point assignment module 360 can assign the echo point to the first or second set of echo points 340a, 340b based on the intensity value of the echo point. As an alternative, the echo point assignment module can assign the echo point to the first or second set of echo points 340a, 340b based on the range value of the echo point. As another alternative, the echo point assignment module can assign the echo point to the first or second set of echo points 340a, 340b based on whether the echo point is a penetrable or impenetrable point.

At step 530, the feature generation module 370 may cause the processor 310 to generate a first set of feature maps 340c based on the first set of echo points 340a and a second set of feature maps 340d based on the second set of echo points 340b, as described above.

At step 540, the feature generation module 370 may cause the processor 310 to generate ROI features 340e based on the sensor data. In one embodiment, the feature generation module 370 can generate ROI features 340e based on the first and second sets of feature maps 340c, 340d. In another embodiment, the feature generation module 370 can generate ROI features 340e based on the bounding box proposals 140 and the first and second sets of feature maps 340c, 340d.

At step 550, the bounding box generation module 380 may cause the processor 310 to predict a bounding box 150 based on the first and second sets of feature maps 340c, 340d. In one embodiment, the bounding box generation module 380 can predict the bounding box 150 by applying machine learning techniques to the ROI features 340e. The bounding box generation module 380 may output the predicted bounding box 150 to any suitable device or system.

At step 560, the object classification module 390 may cause the processor 310 to classify the object based on the first and second sets of feature maps 340c, 340d. More specifically, the object classification module 390 may classify the object and associate the object with an object class 160 by applying machine learning techniques to the ROI features 340e. The object classification module 390 may output the object class 160 to any suitable device or system.

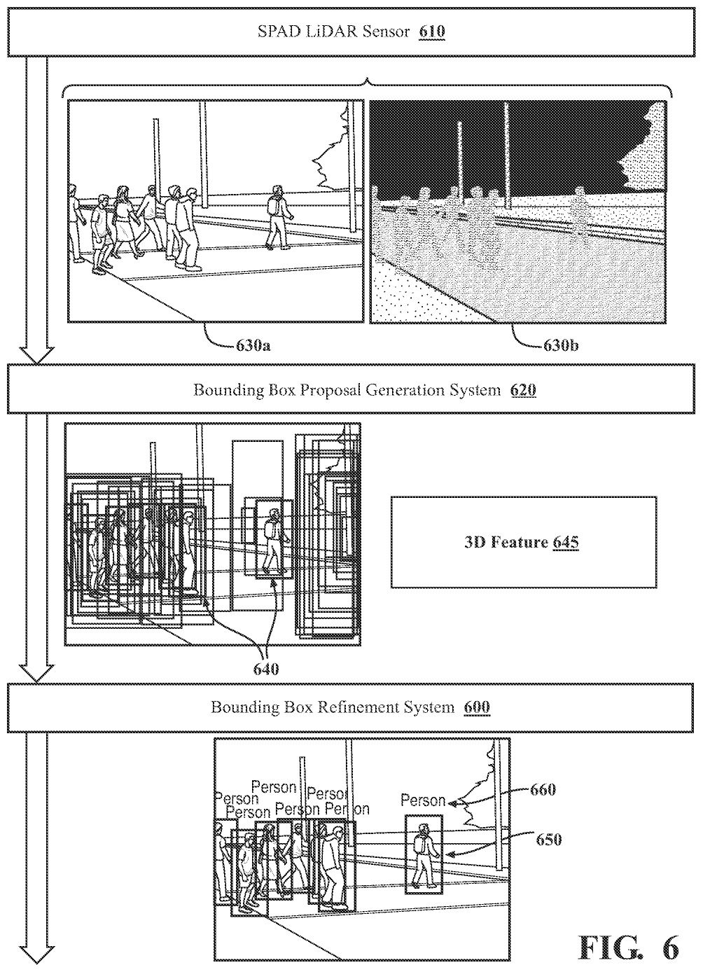

A non-limiting example of the operation of the BBR system 100 and/or one or more of the methods will now be described in relation to FIG. 6. FIG. 6 shows an example of a bounding box refinement and an object classification scenario with a sensor located at a crosswalk.

In FIG. 6, the BBR system 600, which is similar to the BBR system 100, receives bounding box proposals 640 and 3D features 645 from the BBPG system 620. The BBPG system 620, which is similar to the BBPG system 120, receives sensor data 630a, 630b from a SPAD LiDAR sensor 610 that is located near a pedestrian crosswalk.

The BBPG system 620 can generate and output bounding box proposals 640 and 3D features 645 based on applying machine learning techniques to processed sensor data 630a, 630b. The BBR system 600 can receive the bounding box proposals 640, the 3D features 645, as well as any other relevant information from the BBPG system 620.

Upon receipt, the BBR system 600 can assign the echo points related to the received 3D features 645 to the first set or the second set of echo points 340a, 340b, as previously mentioned. The BBR system 600 can learn a first and a second set of feature maps 340c, 340d by using suitable machine learning techniques on the first and second set of echo points 340a, 340b respectively. The BBR system 600 can concatenate the first and second sets of feature maps 340c, 340d. The BBR system 600 can then apply any suitable machine learning technique to the concatenated feature maps 340c, 340d to learn the ROI features 340e. Finally, the BBR system 600 can also apply machine learning techniques to the ROI features 340e to determine a bounding box 650 for the detected objects as well as an object class, such in this case, person 660.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, another magnetic medium, an ASIC, a CD, another optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term, and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that, when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method for detecting an object comprising:
receiving sensor data, the sensor data based on information from a first set of echo points and a second set of echo points, at least one echo point from the first set of echo points and one echo point from the second set of echo points originating from a single beam;
generating a first set of feature maps based on the first set of echo points and a second set of feature maps based on the second set of echo points; and
predicting a bounding box for the object based on the first set of feature maps and the second set of feature maps.

2. The method of claim 1, further comprising:
classifying the object based on the first set of feature maps and the second set of feature maps.

3. The method of claim 1, wherein the sensor data is based on at least one of a plurality of bounding box proposals and 3-dimensional (3D) features.

4. The method of claim 3, further comprising:
generating region of interest (ROI) features based on the plurality of bounding box proposals, the first set of feature maps, and the second set of feature maps; and
predicting the bounding box based on the ROI features.

5. The method of claim 4, further comprising:
classifying the object based on the ROI features.

6. The method of claim 1, further comprising:
assigning an echo point to the first set of echo points or the second set of echo points based on an intensity value of the echo point.

7. The method of claim 1, further comprising:
assigning an echo point to the first set of echo points or the second set of echo points based on a range value of the echo point.

8. The method of claim 1, further comprising:
assigning an echo point to the first set of echo points or the second set of echo points based on whether the echo point is a penetrable or impenetrable point.

9. A system for detecting an object comprising:
a processor; and
a memory in communication with the processor, the memory including:
a feature generation module including instructions that when executed by the processor cause the processor to:
receive sensor data, the sensor data based on information from a first set of echo points and a second set of echo points, at least one echo point from the first set of echo points and one echo point from the second set of echo points originating from a single beam; and
generate a first set of feature maps based on the first set of echo points and a second set of feature maps based on the second set of echo points; and
a bounding box generation module including instructions that when executed by the processor cause the processor to:
predict a bounding box for the object based on the first set of feature maps and the second set of feature maps.

10. The system of claim 9, wherein the memory further includes:
an object classification module including instructions that when executed by the processor cause the processor to:
classify the object based on the first set of feature maps and the second set of feature maps.

11. The system of claim 9, wherein the sensor data is based on at least one of a plurality of bounding box proposals and 3-dimensional (3D) features.

12. The system of claim 11, wherein the memory further includes:
the feature generation module including instructions that when executed by the processor cause the processor to:
generate ROI features based on the plurality of bounding box proposals, the first set of feature maps, and the second set of feature maps; and
the bounding box generation module including instructions that when executed by the processor cause the processor to:
predict the bounding box based on the ROI features.

13. The system of claim 12, wherein the memory further includes:
an object classification module including instructions that when executed by the processor cause the processor to:
classify the object based on the ROI features.

14. The system of claim 9, wherein the memory further includes:
an echo point assignment module including instructions that when executed by the processor cause the processor to:
determine whether to assign an echo point to the first set of echo points or the second set of echo points based on an intensity value of the echo point.

15. The system of claim 9, wherein the memory further includes:
an echo point assignment module including instructions that when executed by the processor cause the processor to:
determine whether to assign an echo point to the first set of echo points or the second set of echo points based on a range value of the echo point.

16. The system of claim 9, wherein the memory further includes:
an echo point assignment module including instructions that when executed by the processor cause the processor to:
determine whether to assign an echo point to the first set of echo points or the second set of echo points based on whether the echo point is a penetrable point or an impenetrable point.

17. A non-transitory computer-readable medium for detecting an object and including instructions that when executed by a processor cause the processor to:
receive sensor data, the sensor data based on information from a first set of echo points and a second set of echo points, at least one echo point from the first set of echo points and one echo point from the second set of echo points originating from a single beam;
generate a first set of feature maps based on the first set of echo points and a second set of feature maps based on the second set of echo points; and
predict a bounding box for the object based on the first set of feature maps and the second set of feature maps.

18. The non-transitory computer-readable medium of claim 17, wherein the instructions further include instructions to:
classify the object based on the first set of feature maps and the second set of feature maps.

19. The non-transitory computer-readable medium of claim 17, wherein the sensor data is based on at least one of a plurality of bounding box proposals and 3-dimensional (3D) features.

20. The non-transitory computer-readable medium of claim 19, wherein the instructions further include instructions to:
generate region of interest (ROI) features based on the plurality of bounding box proposals, the first set of feature maps, and the second set of feature maps; and
predict the bounding box based on the ROI features.
